(19) United States
(12) Patent Application Publication
(10) Pub. No.: US 2018/0051511 A1
(43) Pub. Date: Feb. 22, 2018

(54) Adaptable Assembly

(71) Applicant: The University of Sydney, Sydeney NSW (AU)

(72) Inventors: Gianluca Ranzi, Pyrnont NSW (AU); Francesco Fiorito, Darlinghurst NSW (AU); Michele Sauchelli, Milano (IT)

(21) Appl. No.: 15/560,928

(22) PCT Filed: Mar. 24, 2016
(86) PCT No.: PCT/AU2016/050226

§ 371 Date: Sep. 22, 2017

(30) Foreign Application Priority Data
Mar. 25, 2015 (AU) 2015901079

(51) Int. Cl. E06B 9/262; E04F 10/04

(52) U.S. Cl. CPC E06B 9/262; E06B 2009/2625; E04F 10/04

(57) ABSTRACT

Disclosed herein is an adaptable assembly (10) comprising an elastically deformable sheet (12) for at least partially covering an opening. The sheet (12) has a higher flexural rigidity in the first direction A than in the second direction B. At least one actuator (16) is connected to the sheet (12) at two or more points spaced apart in the second direction B. When actuated, the actuator (16) is configured to apply a force between the two or more points to cause the sheet (12) to elastically deform from an initial configuration to an actuated configuration.

### CROSS-REFERENCE TO RELATED APPLICATIONS

The present application is a U.S. National Stage patent application of International Patent Application No. PCT/AU2016/050226, filed on 24 Mar., 2016, which claims priority to Australian Provisional Patent Application No 2015901079, filed on 25 Mar., 2015, the disclosures of which are hereby incorporated by reference in their entirety.

### TECHNICAL FIELD

The present disclosure relates to an adaptable assembly. The assembly has been developed primarily for use as an adaptable shading device for windows, facades or outdoor shading installations, and will be described hereinafter with reference to this application. However, the assembly is not limited to this application and may also be used, for example, as a shading device on other architectural openings, such as doorways, or as an awning or protective apparatus whether or not associated with an architectural opening, or indeed as a lid or cover for a vent, or as a valve member for controlling flow in a fluid circuit.

### BACKGROUND

Solar radiation has a significant impact on the overall energy needs of a building, particularly with regard to the energy needs associated with heating and cooling. As such, solar control in high energy efficient buildings is fundamental and in some cases also vital for indoor comfort.

To improve the energy efficiency of a building, it is common to use solar shading devices, such as awnings or shutters, on windows. Many such shading devices must be manually moved between their closed and open configurations. More sophisticated shading devices include a motorised system to facilitate opening and closing. The provision of a motorised system, however, increases the capital cost and maintenance costs of a shading device.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Throughout this specification:
a. the word “comprise”, or variations such as “comprises” or “comprising”, will be understood to imply the inclusion of a stated element, integer or step, or group of elements, integers or steps, but not the exclusion of any other element, integer or step, or group of elements, integers or steps; and
b. the word “opening”, when used as a noun, will be understood to include, but not necessarily be limited to, a space or void that may, or may not, have an associated closure, such as closure in the form of a door, window pane or screen.

In a first aspect, there is provided an adaptable assembly for at least partially covering an opening, comprising:

an elastically deformable sheet for at least partially covering an opening, wherein the sheet's flexural rigidity in a first direction is higher than the sheet's flexural rigidity in a second direction; and

at least one actuator connected to the sheet at two or more points spaced apart in the second direction,

wherein, when actuated, the at least one actuator is configured to apply a force between the two or more points to cause the sheet to elastically deform from an initial configuration to an actuated configuration for adjusting an exposure of the opening.

The at least one actuator may be at least one linear actuator.

Projections may be defined on at least one side of the sheet, the projections being spaced apart in the second direction. The two or more points may be on the projections.

The sheet may be corrugated to provide the higher flexural rigidity of the sheet in the first direction than in the second direction. The two or more points may be on peaks and/or troughs of the corrugated sheet. The two or more points may be at or adjacent the apexes of the respective peaks and/or troughs of the corrugated sheet. Alternatively, or in addition, the sheet may have areas of relative flexural weakness, such as by providing creases, grooves or penetrations in the sheet, to provide the higher flexural rigidity of the sheet in the first direction than in the second direction and/or to otherwise modify the relative flexural rigidity between other areas of the sheet.

The sheet may have corrugations that are regularly or irregularly spaced and/or regularly or irregularly shaped, including but not limited to corrugations of different shapes/forms and/or heights. For example, the corrugations may have a generally sinusoidal, saw-tooth, square or triangular wave form, or a combination thereof.

The at least one actuator may comprise a stimulus responsive material, such as a shape change material (SCM) or a shape memory material (SMM). The stimulus responsive material may be responsive to one or more stimuli selected from the group consisting of: thermal stimuli, photo stimuli, electrical stimuli, chemical stimuli, magnetic stimuli, and hydro stimuli. The actuator may comprise a SCM in the form of an electro-active polymer or a piezo-electric material. The at least one actuator may comprise a SMM in the form of a shape memory alloy, a shape memory polymer, a shape memory hybrid, a shape memory ceramic, a shape memory gel or a thermo bi-metal. The at least one actuator may comprise a thermo-responsive shape memory alloy, such as a NiTi-based alloy, a Cu-based alloy or a Fe-based alloy. The at least one actuator may comprise a shape memory polymer in the form of a physically cross-linked polymer, such as thermoplastic polyurethane, or a chemically cross-linked polymer, such as epoxy SMP. The at least one actuator may have a shorter axial length prior to actuation and a longer axial length after actuation, or vice versa. For example, the at least one actuator may have a substantially helical configuration prior to actuation and a substantially linear configuration after actuation, or vice versa. The at least one actuator may be responsive to a plurality of stimuli, for example to allow both passive actuation, such as thermal actuation, and active actuation, such as electrical actuation.

Upon de-actuation of the at least one actuator, the flexural rigidity of the sheet in the second direction may cause the sheet to return to the initial configuration.

The at least one actuator may comprise a plurality of the actuators, each extending between at least two points spaced apart in the second direction. For example, in the case of a corrugated sheet, each of the plurality of actuators may extend between peaks and/or troughs of the corrugated sheet. The actuators may be connected in series, in parallel, or in a combination of series and parallel. Some of the actuators may be located at different heights of the sheet's corrugations to other of the actuators. Actuators with different characteristics may be provided at different locations on the sheet to generate a desired actuated configuration of the sheet. Alternatively, or in addition, actuation of some of the actuators may be damped relative to other of the actuators, for example by limiting exposure of a stimulus responsive actuator to its associated stimulant. In the case of a thermally responsive actuator, such damping may be provided by insulating or shielding the actuator or by forming the actuator from or coating it with a light coloured or reflective material.

The two or more points may be spaced apart in both the first direction and the second direction.

One end of the sheet may be adapted for connection to a structure, such as structure comprising an opening to be at least partially covered by the assembly, in which case the assembly may be adapted for connection to the structure adjacent the opening. The assembly may be configured for cantilevered connection to the structure.

The assembly may be a cover assembly for an architectural opening, such as a window or doorway.

In a second embodiment, there is provided a system for at least partially covering an opening, comprising:

a first assembly according to the first aspect above and adapted for connection adjacent the opening; and

a second assembly according to the first aspect above and adapted for connection adjacent the opening,

wherein, in use, when moving between the initial and actuated configurations, the first and second assemblies cooperatively adjust exposure of the opening.

When moving between the initial and actuated configurations, the first and second assemblies may be configured to move toward and away from one another.

In a third aspect, there is provided a structure comprising:
a body having an opening associated therewith; and
either:
   a single assembly according to the first aspect above connected to the body adjacent the opening, or
   a system according to the second aspect above, wherein the first and second assemblies of the system are connected to the body adjacent the opening.

The structure may comprise at least one said assembly that is cantilevered from the body.

The opening associated with the body may be an opening in the body. For example, the opening may be a window or doorway in the structure.

In a fourth aspect, there is provided a method of at least partially covering and exposing an opening, comprising:

installing an adaptable assembly according to the first aspect above adjacent an opening; and

actuating the at least one actuator to elastically deform the sheet from the initial configuration to the actuated configuration to adjust exposure of the opening.

The method may further comprise de-actuating the at least one actuator, and allowing the flexural rigidity of the sheet in the second direction to return the sheet to the initial configuration.

The method may comprise installing a first adaptable assembly according to the first aspect above adjacent the opening, installing a second adaptable assembly according to the first aspect above adjacent the opening, and using the first and second assemblies cooperatively to adjust exposure of the opening.

The at least one actuator may be passively actuated and/or actively actuated.

### BRIEF DESCRIPTION OF DRAWINGS

Embodiments of the presently disclosed assembly and method will now be described, by way of example only, with reference to the accompanying drawings, in which:

FIG. 1 is a schematic perspective view of a first embodiment of the adaptable assembly in an initial state;

FIGS. 2a and 2b are schematic elevational views of the adaptable assembly of FIG. 1, respectively in an initial state and an actuated state;

FIGS. 3a and 3b are schematic views of adaptable assemblies, as shown in FIG. 1, installed adjacent a window, respectively in an initial configuration and an actuated configuration;

FIGS. 4a and 4b are schematic views of an embodiment of a system comprising cooperative pairs of adaptable assemblies, as shown in FIG. 1, installed adjacent a window, respectively in an initial configuration and an actuated configuration;

FIG. 5 is a schematic elevational view of a second embodiment of the adaptable assembly, similar to the embodiment of FIG. 1, in an initial state;

FIGS. 6a and 6b are schematic elevational views of alternative embodiments of the adaptable assembly, similar to the embodiment of FIG. 1, in an initial state; and

FIGS. 7a and 7b are schematic elevational views of alternative embodiments of the adaptable assembly, similar to the embodiment of FIG. 1, in an initial state.

### DESCRIPTION OF EMBODIMENTS

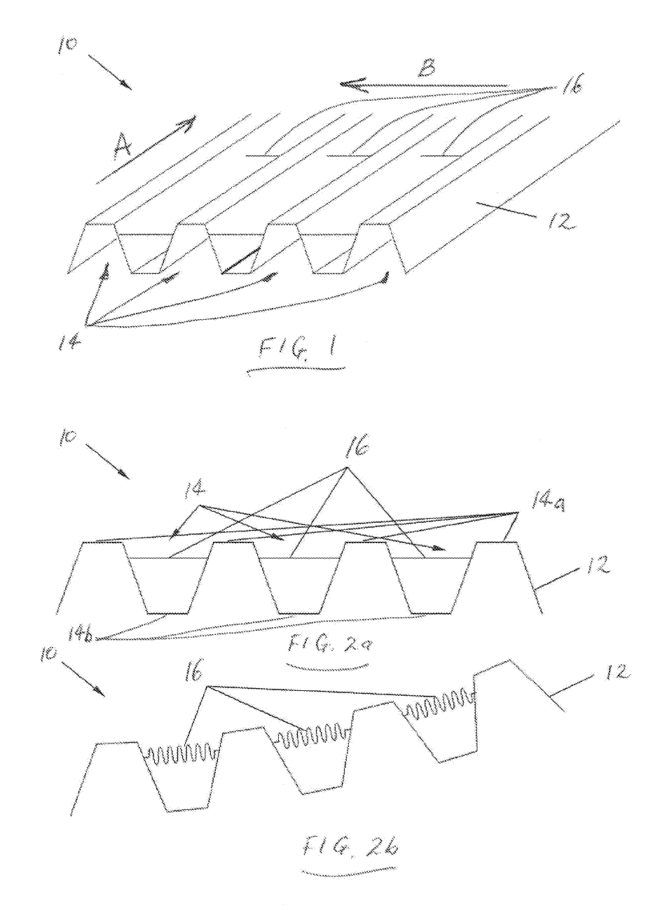

Referring to the drawings, and initially to FIGS. 1, 2a and 2b, there is shown an adaptable assembly 10 comprising an elastically deformable steel sheet 12 for at least partially covering an opening. The sheet 12 is corrugated, having parallel corrugations 14 extending across the sheet in a first direction A and being spaced apart along the sheet in a second direction B. Accordingly, the sheet 12 has a higher flexural rigidity in the first direction A than in the second direction B. That is, the sheet 12 is easier to bend around an axis parallel to the corrugations 14 than it is to bend around an axis perpendicular to the corrugations.

A plurality of linear actuators 16 extend in series between the corrugations 14 and are connected to the sheet 12 part way up the peaks 14a of the corrugations. In other embodiments, the actuators may be connected to the sheet at other locations, such as at the apex of the peaks 14a or at other amplitudes of the corrugations. When actuated, the actuators 16 are configured to apply a force between the peaks 14a to cause the sheet 12 to elastically deform from an initial configuration, as shown in FIGS. 1 and 2a, to an actuated configuration, as shown in FIG. 2b. Upon de-actuation of the actuator 16, the flexural rigidity of the sheet 12 in the second direction B causes the sheet to return to the initial configuration of FIGS. 1 and 2a.

In the illustrated embodiments, the actuators 16 are formed from a NiTi-based shape memory alloy, and are configured to reduce in axial length by adopting a helical (spring) shape upon thermal stimulation, as best seen by comparing FIGS. 2a and 2b. However, in other embodiments, the actuators 16 may be formed from another shape memory alloy, such as a Cu-based alloy or a Fe-based alloy. In yet further embodiments, the actuators 16 may comprise an alternative stimulus responsive material, which may be a shape change material (SCM) or a shape memory material (SMM), and may be responsive to an alternative stimulus, such as electrical stimulus, photo stimulus, magnetic stimulus, or hydro stimulus. For example, in another embodiment, the actuators 16 may comprise an electro-active polymer; a piezo-electric material; a shape memory polymer in the form of a physically cross-linked polymer, such as thermoplastic polyurethane, or a chemically cross-linked polymer, such as epoxy SMP; a shape memory hybrid; a shape memory ceramic; or a shape memory gel.

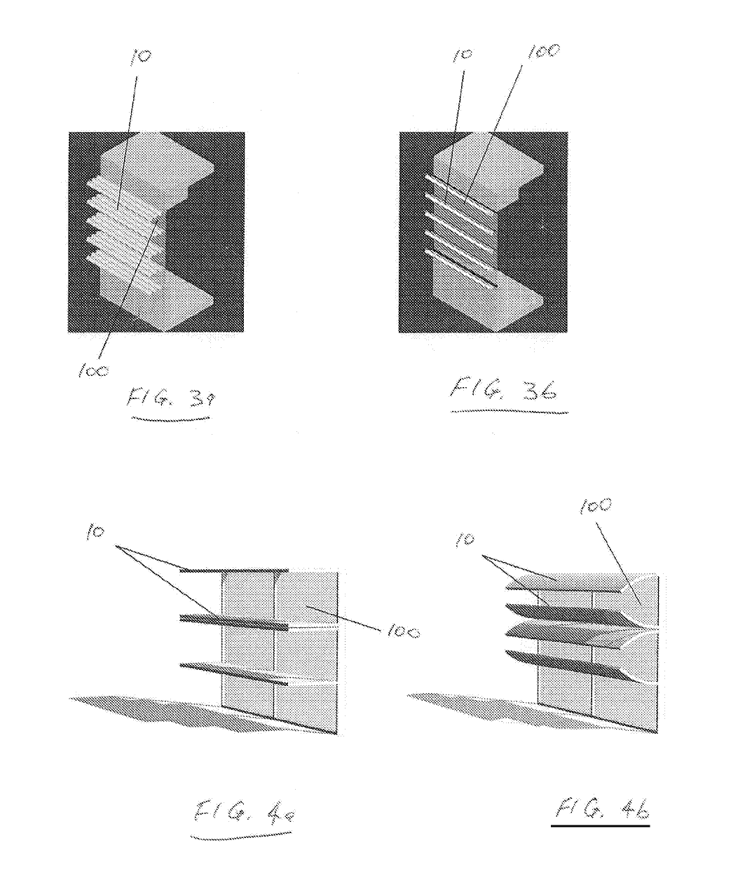

FIGS. 3a and 3b show assemblies 10 connected adjacent lower sides of the windows 100 of a building and acting as awnings for automatically adjusting exposure of the windows in response to changes in ambient temperature. The sheets 12 of the assemblies 10 are connected at one end to the building and are cantilevered therefrom so as to extend generally horizontally from the building. In the embodiment shown in FIGS. 3a and 3b, the actuators 16 are located on the top side of the sheets 12. When ambient temperature increases and stimulates the actuators 16, the actuators shorten, by adopting their helical shape, and elastically deform the sheets 12 about a generally horizontal axis, causing the free ends of the sheets to rotate upwardly from the initial configuration of FIG. 3a to the actuated configuration of FIG. 3b to reduce exposure of the windows 100. In other embodiments, the assemblies may be connected adjacent the upper sides of the windows 100 and the actuators may be located on the underside of the sheets to cause the free ends of the sheets to rotate downwardly to reduce exposure of the windows 100. In other embodiments, the sheets 12 have a different initial configuration, such as a curved configuration, suited to the shading needs of the particular installation. The assembly 10 can also be applied in double-skin facades, in which case it would be placed in between the two skins. In yet further embodiments, the assemblies 10 may be installed vertically on a building, such that they cause the sheets to rotate about a vertical axis to adjust exposure of the windows 100. When surface temperature reduces, the flexural rigidity of the sheets 12 returns the apparatus to the initial configuration of FIG. 3a.

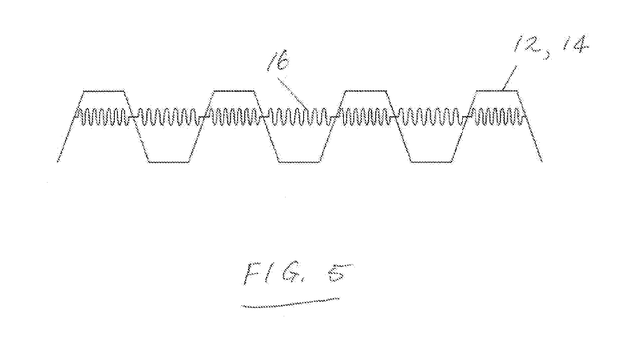

FIGS. 4a and 4b show pairs of assemblies 10 installed on opposite sides of building windows 100 and which cooperate to adjust exposure of the windows. The assembly 10 at the top of each window has actuators located on the underside of the sheet 12 and the assembly at the bottom of each window has actuators located on the top side of the sheet 12. Accordingly, when the actuators 16 are actuated, the assembly at the top of each window rotates downwardly from the configuration shown in FIG. 4a to that shown in FIG. 4b and the assembly at the bottom of each window rotates upwardly from the configuration shown in FIG. 4a to the configuration shown in FIG. 4b to reduce exposure of the window.

It will be appreciated that the presently disclosed assembly 10 advantageously provides for automatic adjustment of the exposure of windows in buildings in response to changing environmental conditions. Moreover, the use of a shape memory alloy for the actuator 16 advantageously avoids the maintenance issues associated with conventional mechanical actuators. By using the shape memory alloy actuators with an elastic sheet, the need for a device to return the sheet to its original configuration is avoided, as the necessary return force is advantageously provided by the flexural rigidity of the sheet itself.

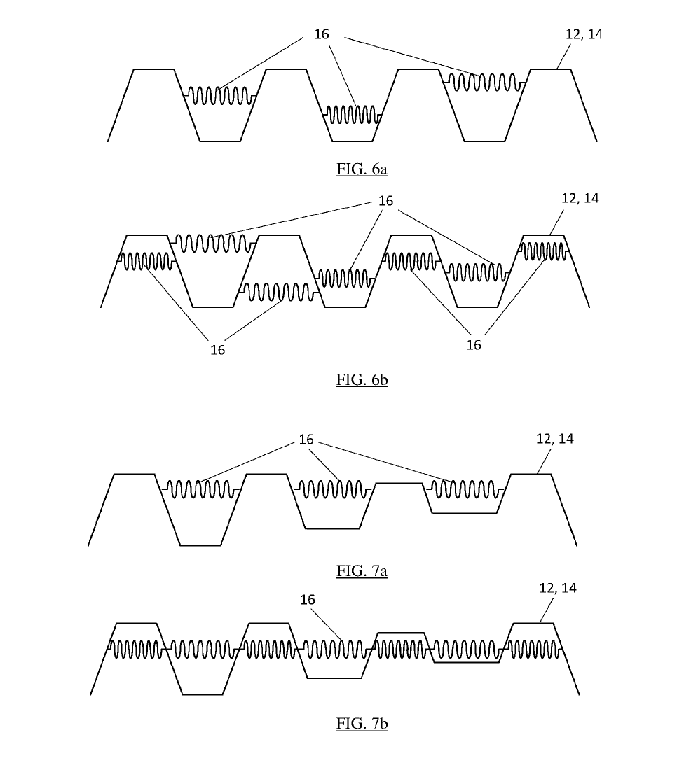

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. Examples of possible variations and/or modifications include, but are not limited to:
installing actuators 16 between troughs 14b of the corrugations as well as between the peaks 14a;
installing the actuators 16 through openings in the sides of the corrugations 14, as shown in FIG. 5, to cause the sheet 12 to shorten in a concertina fashion upon actuation of the actuators;
installing the actuators 16 associated with adjacent corrugations at different heights, such as shown in FIGS. 6a and 6b, to facilitate generation of more complex actuated configurations of the sheet 12, including both single and double curvatures, without requiring the use of different actuators;
irregularly spacing the corrugations along the sheet;
providing corrugations of a different configuration to the trapezoidal wave form shown in the drawings, including but not limited to different shapes/forms and heights, such as corrugations of a sinusoidal, square, rectangular, saw-tooth or triangular wave form, corrugations of irregular shape, and/or corrugations of differing heights, with examples of sheets 12 with differently configured corrugations being shown in FIGS. 7a and 7b, wherein such variations in configuration of the corrugations may facilitate generation of more complex actuated configurations of the sheet 12 and/or provide differing degrees of flexural resistance to the morphing deformations generated by the actuators 16;
providing areas of local relative flexural weakness in the sheet 12, such as by providing creases, grooves or penetrations of different forms and dimensions in the sheet, wherein the areas of local relative flexural weakness may facilitate generation of more complex actuated configurations of the sheet 12 and/or provide differing degrees of flexural resistance to the morphing deformations generated by the actuators 16
the points at which each actuator 16 is connected to the sheet 12 may be spaced apart in both direction A and direction B, such that the actuators 16 are oriented at an angle offset from perpendicular to the longitudinal axis of the corrugations, thereby causing the actuators 16 to apply a torsional force to the sheet 12, which may facilitate the formation of more complex actuated configurations of the sheet 12;
controlling the heat transfer within the assembly 10 and to selected linear actuators 16, for example by insulating one or more selected actuators 16 or by varying the thermal response of different components of the assembly 10 or associated elements by varying the colour scheme of the assembly 10 or associated elements, which may facilitate modification of the time at which particular actuators 16 are actuated;
using an actuator that increases in length when actuated;
using an actuator that is a non-linear actuator;
using an actuator that is responsive to several stimuli, or a plurality of different actuators each responsive to a different stimuli, such as thermal and electrical stimulation, to allow both passive actuation, such as via thermal actuation, and active actuation, such as via electrical actuation;
connecting the actuators in parallel, or in a combination of series and parallel;
using actuators with different characteristics at different locations on the sheet to generate a desired actuated configuration of the sheet, for example by using thermoresponsive actuators that are actuated at different temperatures at different locations on the sheet, wherein the different actuating temperatures of the actuators may be achieved, for example, by using otherwise identical actuators painted in different colours to vary their solar reflectivity or by using thermally responsive materials that are actuated at different temperatures to differentiate the thermal response between the actuators;
substituting stimulus responsive actuators 16 with mechanical actuators or using stimulus responsive actuators 16 in combination with mechanical actuators;
forming sheet 12 from a different material, for example from a different metal, such as aluminium, stainless steel, or from plastics, wood or composites, or a combination thereof;
substituting sheet 12 with a non-corrugated sheet and providing the sheet with a higher flexural rigidity in the first direction A using ribs or other strengthening elements extending across the sheet;
using the adaptable assembly 10 to cover a different type of opening, such as a doorway or vent, or as a valve member for controlling flow in a fluid circuit; and/or
using the adaptable assembly 10 as or in an adaptable awning or protective apparatus regardless of whether the awning or protective apparatus is associated with an opening, such as for protecting an area adjacent a structure from exposure to sun or rain.

1. An adaptable assembly for at least partially covering an opening, comprising:
an elastically deformable sheet for at least partially covering an opening, wherein the sheet's flexural rigidity in a first direction is higher than the sheet's flexural rigidity in a second direction; and
at least one actuator connected to the sheet at two or more points spaced apart in the second direction,
wherein, when actuated, the at least one actuator is configured to apply a force between the two or more points to cause the sheet to elastically deform from an initial configuration to an actuated configuration for adjusting an exposure of the opening.

2. An assembly according to claim 1, wherein the at least one actuator is at least one linear actuator.

3. An assembly according to claim 1, wherein projections are defined on at least one side of the sheet, the projections being spaced apart in the second direction, and wherein the two or more points are on the projections.

4. An assembly according to claim 1, wherein the sheet is corrugated to provide the higher flexural rigidity of the sheet in the first direction than in the second direction.

5. An assembly according to claim 4, wherein the two or more points are associated with respective peaks and/or troughs of the corrugated sheet.

6. An assembly according to claim 5, wherein the two or more points are at or adjacent apexes of the respective peaks and/or troughs of the corrugated sheet.

7. An assembly according to claim 4, wherein the sheet has corrugations that are regularly or irregularly spaced and/or regularly or irregularly shaped.

8. An assembly according to claim 4, comprising areas of relative flexural weakness in addition to those created by the sheet being corrugated.

9. An assembly according to claim 1, wherein the at least one actuator comprises a stimulus responsive material.

10. An assembly according to claim 9, wherein the stimulus responsive material is responsive to any one or more stimuli selected from the group consisting of: thermal stimuli, photo stimuli, electrical stimuli, magnetic stimuli, chemical stimuli, and hydro stimuli.

11. An assembly according to claim 9, wherein the stimulus responsive material comprises a shape change material (SCM) or a shape memory material (SMM).

12. An assembly according to claim 11, wherein the stimulus responsive material comprises a SMM selected from the group consisting of: a shape memory alloy, a shape memory polymer, a shape memory hybrid, a shape memory ceramic, a shape memory gel and a thermo bi-metal.

13. An assembly according to claim 11, wherein the stimulus responsive material comprises a SCM in the form of an electro-active polymer or a piezo-electric material.

14. An assembly according to claim 1, wherein the at least one actuator has a shorter axial length prior to actuation and a longer axial length after actuation, a longer axial length prior to actuation and a shorter axial length after actuation, or wherein the at least one actuator comprises a plurality of actuators, wherein some of the plurality of actuators have a shorter axial length prior to actuation and a longer axial length after actuation and other of the plurality of actuators have a longer axial length prior to actuation and a shorter axial length after actuation.

15. An assembly according to claim 1, wherein, upon de-actuation of the at least one actuator, the flexural rigidity of the sheet in the second direction causes the sheet to return to the initial configuration.

16. An assembly according to claim 1, wherein the at least one actuator comprises a plurality of the actuators, each extending between at least two points spaced apart in the second direction.

17. An assembly according to claim 16, wherein the actuators are connected in series or in parallel or in a combination of series and parallel.

18. An assembly according to claim 16, wherein actuators with different characteristics are provided at different locations on the sheet to generate a desired actuated configuration of the sheet.

19. (canceled)

20. (canceled)

21. (canceled)

22. A system for at least partially covering an opening, comprising:
a first assembly according to claim 1 and adapted for connection adjacent the opening; and
a second assembly according to claim 1 and adapted for connection adjacent the opening,
wherein, in use, when moving between the initial and actuated configurations, the first and second assemblies cooperatively adjust exposure of the opening.

23. (canceled)

24. (canceled)

25. A method of at least partially covering and exposing an opening, comprising:
installing an adaptable assembly according to claim 1 adjacent an opening; and
actuating the at least one actuator to elastically deform the sheet from the initial configuration to the actuated configuration to adjust exposure of the opening.

26. A method according to claim 25, further comprising de-actuating the at least one actuator, and allowing the flexural rigidity of the sheet in the second direction to return the sheet to the initial configuration.

27. A method according to claim 25, comprising installing a first said adaptable assembly adjacent the opening, installing a second said adaptable assembly adjacent the opening, and using the first and second assemblies cooperatively to adjust exposure of the opening.

28. (canceled)

29. (canceled)
